(19) United States
(12) Patent Application Publication
(10) Pub. No.: US 2020/0374366 A1
(43) Pub. Date: Nov. 26, 2020

(54) METHOD AND SYSTEM FOR COMMUNICATION BETWEEN TWO DEVICES

(71) Applicant: BULL SAS, Les Clayes-sous-Bois (FR)

(72) Inventors: Zoltan MENYHART, GRENOBLE (FR); Saïd DERRADJI, ISSY LES MOULINEAUX (FR)

(21) Appl. No.: 16/759,009

(22) PCT Filed: Oct. 22, 2018
(86) PCT No.: PCT/FR2018/052615

§ 371 Date: Apr. 24, 2020

(30) Foreign Application Priority Data
Oct. 25, 2017 (FR) 1771121

(51) Int. Cl. H04L 29/08; H04L 12/801; H04L 29/06; H04L 1/18

(52) U.S. Cl. CPC H04L 67/32; H04L 1/188; H04L 69/163; H04L 47/193

(57) ABSTRACT

A method for communication between first and second devices includes the following stages: the first device sends a request to the second device; the second device receives the request; the second device sends the first device a response to the request; the first device receives the response; the second device estimates a period after which it will be able to send the response, as well as, in at least some cases, the following steps: before sending the response, the second device sends an acknowledgement to the first device, the acknowledgement including the estimated period; the first device receives the acknowledgement; the first device calculates a time interval based on the estimated period; the first device allows the time interval to elapse before starting to monitor the arrival of messages to detect the arrival of the response.

The present invention relates to a method and a system for communication between first and second devices.

The invention applies more particularly to a method for communication between first and second devices connected to one another, the method including the following steps:
the first device sends a request to the second device,
the second device receives the request,
the second device sends the first device a response to the request,
the first device receives the response.

In such a method, when the first device has sent the request, it starts to monitor the arrival of messages in order to detect the arrival of the response to the request thereof. Once this arrival has been detected, the first device retrieves the response in order to be able to process same. When the response is ready to be processed, it is considered as received.

It may be sought to provide a method for communication between first and second devices which makes it possible to optimize the use of the hardware resources of the first device.

An object of the invention is therefore a method for communication between first and second devices connected to one another, the method including the following steps:
the first device sends a request to the second device,
the second device receives the request,
the second device sends the first device a response to the request,
the first device receives the response,
   the method being characterized in that it further includes the following step:
the second device estimates a period after which the second device will be able to send the response,
   and, in at least some cases, the following steps:
before sending the response, the second device sends an acknowledgement to the first device, the acknowledgement including the estimated period,
the first device receives the acknowledgement,
the first device calculates a time interval based on the estimated period,
the first device allows the time interval to elapse before starting to monitor the arrival of messages to detect the arrival of the response.

Thus, thanks to the invention, during the time interval, the first device can carry out other tasks than monitoring the arrival of messages, which enables better use of the hardware resources thereof.

Optionally, the method further includes the following step:
the second device compares the estimated period to a first threshold, and the step of the second device sending the acknowledgement is carried out if the estimated period is greater than the first threshold and is not carried out otherwise, similarly to the other steps dependent on the sending of the acknowledgement.

Also optionally, the estimated period is equal to a mean of periods observed by the second device in responding to requests to which the second device has previously responded.

Also optionally, the method further includes the following step:
the second device determines whether it needs access to a device from a predetermined list of devices,
   and the step of the second device sending the acknowledgement is carried out if such access is required and is not carried out otherwise, similarly to the other steps dependent on the sending of the acknowledgement.

Also optionally, the method further includes the following step:
the first device compares the estimated period to a second threshold, and the step of the first device calculating the time interval is carried out if the estimated period is greater than the second threshold and is not carried out otherwise, similarly to the step consisting of allowing the time interval to elapse before starting to monitor the arrival of messages.

Also optionally, the time interval is taken as proportional to the estimated period, according to a predefined proportion ratio.

It is also proposed to a communication system including first and second devices connected to one another, the first device including software and/or hardware means for:
sending a request to the second device,
receiving, from the second device, an acknowledgement including an estimated period after which the second device will be able to send a response to the request,
calculating a time interval based on the estimated period,
allowing the time interval to elapse before starting to monitor the arrival of messages to detect the arrival of the response,
receiving the response,
   and the second device including software and/or hardware means for:
receiving the request,
estimating the period after which the second device will be able to send the response,
sending, before sending the response, an acknowledgement to the first device, the acknowledgement including the estimated period,
sending the response.

The invention will be better understood using the following description, given merely by way of example and with reference to the appended drawings wherein:

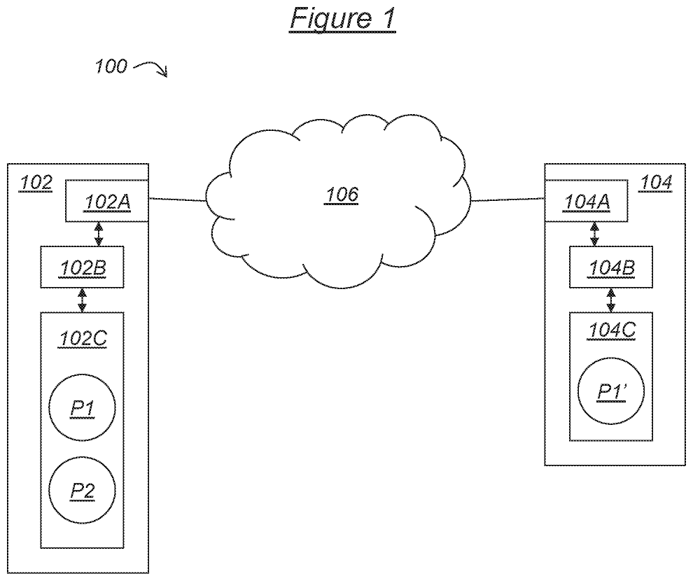

FIG. 1 represents schematically the general structure of a communication system implementing the invention,

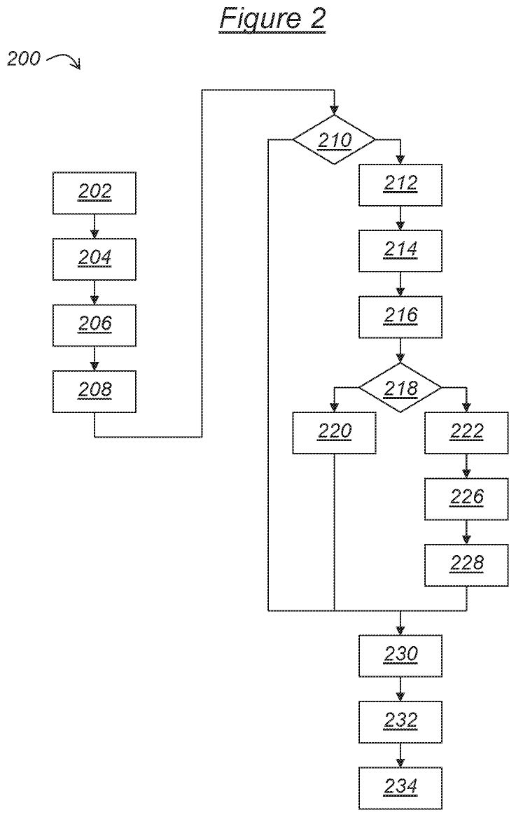

FIG. 2 illustrates the successive steps of a communication method carried out in the communication system in FIG. 1 and implementing the invention, and

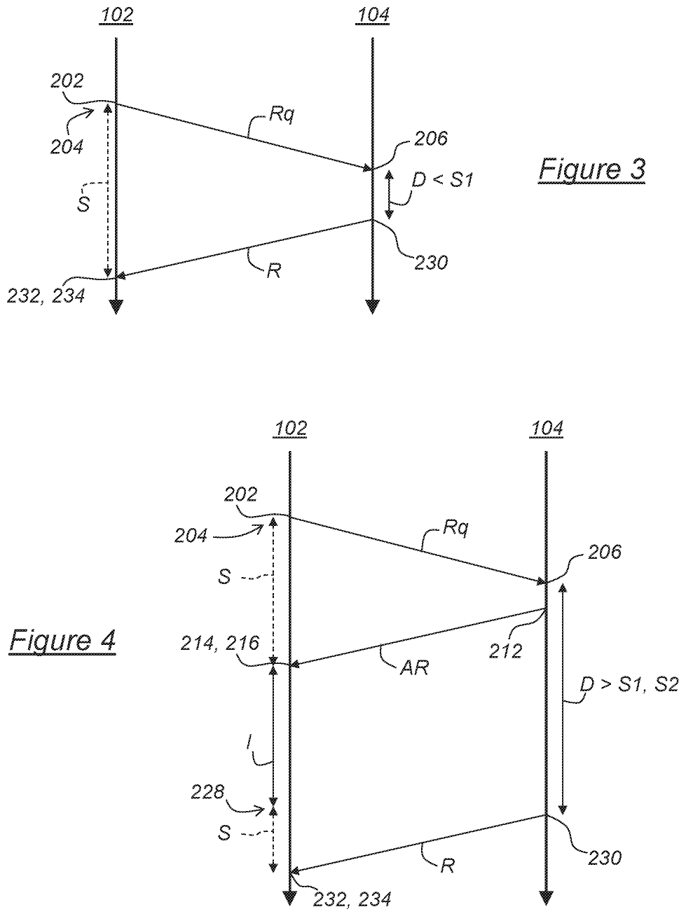

FIGS. 3 and 4 are chronograms illustrating the exchanges between first and second devices of the communication system in FIG. 1, in respectively two different scenarios.

With reference to FIG. 1, a communication system 100 implementing the invention will now be described.

The communication system 100 includes first and second devices 102, 104, as well as a communication network 106 whereby the first and second devices 102, 104 are connected to one another. The communication network 106 is for example the Internet.

In particular, each of the first and second devices 102, 104 includes a network interface 102A, 104A whereby the first device 102, respectively the second device 104, is connected to the communication network 106 to send and receive messages.

Moreover, in the example described, the first and second devices 102, 104 are computing devices each including a processing unit 102B, 104B and a memory 102C, 104C wherein one or more computer programs including instructions intended to be executed by the processing unit 102B, 104B are saved. The processing unit 102B, 104B includes for example a processor and the memory 102C, 104C includes for example a volatile RAM (Random Access Memory) memory. In this case, each of the first and second devices 102, 104 generally includes a non-volatile storage unit (such as a hard drive) not shown, from which the computer program(s) are loaded in the volatile RAM memory for the execution thereof.

Furthermore, in the example described, the memory 102C of the first device 102 includes two programs P1, P2 currently being executed, while the memory 104C of the second device 104 includes a program P1′ currently being executed. The programs P1, P1′ are designed to communicate with one another by exchanging messages via the communication network 106, i.e. by sending and receiving messages.

The receipt of a message means within the scope of the present invention that the message is ready to be processed. For this reason, the receipt of a message is only effective after several phases. Firstly, the message arrives at the device 102, 104, for example the message is saved in the network interface 102A, 104A, but the program P1, P1′ is not yet aware of the arrival thereof. Then, the arrival of the message is detected by the program P1, P1′. In order to detect the arrival of a message, the program P1, P1′ is designed to monitor the arrival of the message by querying from time to time the unit wherein it is saved, the network interface 102A, 104A in the example described (mechanism known as “polling”). The queries may be carried out continuously, in this case the term “busy wait” is generally used, or indeed at regular or irregular intervals over time. In any case, monitoring the arrival of a message uses hardware resources of the device 102, 104. Once the arrival of the message has been detected, the program P1, P1′ retrieves the message for the processing thereof. At this stage, the message is considered as received.

With reference to FIG. 2, a communication method 200 between the first and second devices 102, 104, implementing the invention, will now be described.

In the following example, where it is stated that a device 102, respectively 104, carries out an action, this means that the processing unit 102B, respectively 104B of this device 102, respectively 104, executes the program P1, respectively P1′, to carry out this action.

During a step 202, the first device 102 sends a request to the second device 104.

During a step 204, the first device 102 starts to monitor the arrival of messages to detect the arrival of a message from the second device 104.

During a step 206, the second device 104 receives the request Rq.

During a step 208, the second device 104 estimates a period D after which a response R to the request Rq may be sent. For example, the estimated period D is equal to a mean of periods observed by the second device 104 in responding to requests to which the second device 104 has previously responded.

During a step 210, the second device 104 compares the estimated period D to a threshold S1. The threshold S1 makes it possible to distinguish between the case where the second device 104 can respond immediately to the request Rq and the case where the second device 104 must perform complex and time-consuming operations in order to respond.

If the estimated period D is less than the threshold S1, the method 200 goes directly to the step 230 of sending a response R by the second device 104. Indeed, when the estimated period D is very short, it is not necessary to try to reduce the monitoring time of the first device 102 to execute other tasks instead, as the cost of obtaining this reduction in monitoring time and of switching to another task is liable to be greater than the gain.

On the other hand, if the estimated period D is greater than the threshold S1, the following steps are carried out.

During a step 212, the second device 104 sends the first device 102 an acknowledgement AR including the estimated period D.

During a step 214, the acknowledgement AR arrives at the first device 102.

During a step 216, the first device 102, which is monitoring the arrival of messages, detects the arrival of the acknowledgement AR and retrieves same. The first device 102 then stops monitoring the arrival of messages.

During a step 218, the first device 102 compares the estimated period D to a threshold S2.

If the estimated period D is less than the threshold S2, during a step 220, the first device 102 starts to monitor the arrival of messages. The method 200 then goes directly to the step 230 of sending a response R by the second device 104. Indeed, as for the threshold S1, when the estimated period D is very short, it is not necessary to try to reduce the monitoring time of the first device to execute other tasks instead, as the cost of obtaining this reduction in monitoring time and of switching to another task is liable to be greater than the gain. The threshold S2 is for example chosen according to the data processing speed of the first device 102. For example, a modern computer can take 100 μs to change task (and as much to return to the program P1). Thus, the threshold S2 is for example chosen greater than 200 μs, for example greater than or equal to 1 ms to retain some margin.

On the other hand, if the period D is greater than the threshold S2, the following steps are carried out.

During a step 222, the first device 102 calculates a time interval I based on the period D.

During a step 226, the first device 102 allows the time interval I to elapse before starting to monitor the arrival of messages. In other words, during the time interval I, the first device 102 does not monitor the arrival of messages.

For example, the time interval I is taken as proportional to the estimated period D, according to a predefined proportion ratio. In an embodiment, the time interval I is taken as equal to the estimated period D (proportion ratio equal to 1). Alternatively, the proportion ratio is taken as less than 1, for example between 0.9 and 1. Thus, the chances of starting monitoring before the arrival of the response R, and therefore of detecting the arrival of the response R as soon as it occurs, are increased. Alternatively again, the proportion ratio is taken as greater than 1, for example between 1 and 1.1. Thus, the chances of starting monitoring after the arrival of the response R or indeed shortly before are increased, which makes it possible to reduce the monitoring time.

During the time interval I, as the first device 102 does not monitor the arrival of messages, it can carry out other tasks. For example, the processing unit time freed up can be used by the program P1 to carry out other tasks. Alternatively, the program P1 can be set to sleep mode during the time interval I, which leaves more processing unit time for the program P2 to execute other tasks.

Moreover, the use of the acknowledgement AR with the estimated period D prevents the first device 102 from resending the request when the response period is long. Thus, the resources of the switching network 106 are spared.

During a step 228, once the time interval I has elapsed, the first device 102 starts to monitor the arrival of messages.

During a step 230, the second device 104 sends the response R to the first device 102.

During a step 232, the response R arrives at the first device 102.

During a step 234, the first device 102, which is monitoring the arrival of messages, detects the arrival of the response R and retrieves same. The first device 102 then stops monitoring the arrival of messages and processes the response R.

The response R includes for example the data requested in the request Rq, or indeed, when the second device 104 has not succeeded in obtaining this requested data, a failure indication.

With reference to FIG. 3, the method 200 is illustrated in the form of a chronogram where two vertical arrows represent the timelines of respectively the first and second devices 102, 104. The double arrow designated by the reference “S” indicates the monitoring of the arrival of messages. The method 200 is illustrated in the case where the estimated period D is less than the threshold S1, i.e. in the case where the acknowledgement mechanism is not used.

With reference to FIG. 4, the method 200 is illustrated in the form of a chronogram similar to that in FIG. 3, but in the case where the estimated period D is greater than both the threshold S1 and the threshold S2. As seen in FIG. 4, the first device 102 can carry out other tasks than that of monitoring the arrival of messages, throughout the time interval I. In the absence of the invention, the monitoring would have run from the step 202 to the step 232.

It is obvious that a system and a method for communication such as those described above make it possible to optimize the use of hardware resources of the first device.

It should be noted moreover that the invention is not limited to the embodiments described above. It will indeed be obvious to those skilled in the art that various modifications may be made to the embodiments described above, in the light of the teaching disclosed above.

For example, it is possible to do without the two comparison steps 210, 218 to still send the acknowledgement AR before the response R. Alternatively, since the two comparison steps 210, 218 have more or less the same function, namely not seeking to reduce the monitoring time when the estimated period D is too short, it is possible to only retain one of these two comparison steps 210, 218.

Furthermore, it is possible to replace the comparison step 210 by a step during which the second device 104 determines whether it needs access to a device from a predetermined list of predetermined list of devices considered to be slow. A slow device is for example a hard drive on standby or a device connected to the communication network 106. If such access if not required, the method goes directly to the step 230, otherwise it goes to the step 212.

Furthermore, the programs P1, P1′ may be each composed of several programs.

Furthermore, the method 200 described above is predicated on the messages exchanged being compliant with a communication protocol agreed between the two devices 102, 104. In particular, if the request Rq is not compliant with the protocol, the second device 104 will return, instead of the acknowledgement AR and the response R, a message rejecting the request Rq.

Furthermore, the sending of an acknowledgement does not necessarily mean that a positive response will be sent by the second device 104. Indeed, even after sending an acknowledgement AR, the second device 104 can still subsequently send a response R indicating a failure, for example when the second device 104 detects an error (for example, a necessary resource that has become unavailable) after sending the acknowledgement.

Moreover, although the example described has devices 102, 104 which are computing devices implementing computer programs, the invention is not limited to this scenario. Indeed, the functions associated with the instructions of the computer program(s) could be at least in part micro-programmed or micro-wired in dedicated integrated circuits. Thus, in an alternative embodiment, each of the programs P1, P1′ could be replaced by an electronic device composed solely of digital circuits (with no computer program) to carry out the same functions.

In the following claims, the terms used should not be interpreted as limiting the claims to the embodiments disclosed in the present description, but should be interpreted to include therein any equivalents that the claims are intended to cover due to the wording thereof and which may be envisaged by those skilled in the art by applying their general knowledge to the implementation of the teaching disclosed above.

1. A method for communication between first and second devices connected to one another, the method comprising:
sending by the first device a request to the second device,
receiving by the second device the request,
sending by the second device to the first device a response to the request,
receiving by the first device the response
estimating by the second device a period after which the second device will be able to send the response,
before sending the response, sending by the second device an acknowledgement to the first device, the acknowledgement including the estimated period,
receiving by the first device the acknowledgement,
calculating by the first device a time interval based on the estimated period,
allowing by the first device the time interval to elapse before starting to monitor the arrival of messages to detect the arrival of the response.

2. The method according to claim 1, further comprising:
comparing by the second device the estimated period to a first threshold, and wherein the sending by second device of the acknowledgement is carried out if the estimated period is greater than the first threshold and is not carried out otherwise, similarly to the other steps dependent on the sending of the acknowledgement.

3. The method according to claim 2, wherein the estimated period is equal to a mean of periods observed by the second device in responding to requests to which the second device has previously responded.

4. The method according to claim 1, further comprising:
determining by the second device whether the second device needs access to a device from a predetermined list of devices,
and wherein the sending by the second device of the acknowledgement is carried out if such access is required and is not carried out otherwise, similarly to the other steps dependent on the sending of the acknowledgement.

5. The method according to claim 1, further comprising:
comparing by the first device the estimated period to a second threshold,
and wherein the calculating by first device of the time interval is carried out if the estimated period is greater than the second threshold and is not carried out otherwise, similarly to the step consisting of allowing the time interval to elapse before starting to monitor the arrival of messages.

6. The method according to claim 1, wherein the time interval is taken as proportional to the estimated period, according to a predefined proportion ratio.

7. A communication system including first and second devices connected to one another, the first device including software and/or hardware means for:
sending a request to the second device,
receiving, from the second device, an acknowledgement including an estimated period after which the second device will be able to send a response to the request,
calculating a time interval based on the estimated period,
allowing the time interval to elapse before starting to monitor the arrival of messages to detect the arrival of the response,
receiving the response,
and the second device including software and/or hardware means for:
receiving the request,
estimating the period after which the second device will be able to send the response,
sending, before sending the response, an acknowledgement to the first device, the acknowledgement including the estimated period,
sending the response.
